(19) United States
(12) Patent Application Publication
(10) Pub. No.: US 2012/0036013 A1
(43) Pub. Date: Feb. 9, 2012

(54) SYSTEM AND METHOD FOR DETERMINING A CONSUMER'S LOCATION CODE FROM PAYMENT TRANSACTION DATA

(76) Inventors: Brent Lee Neuhaus, Union City, CA (US); John Gallaudette Wallace, San Francisco, CA (US)

(21) Appl. No.: 12/966,539

(22) Filed: Dec. 13, 2010

Related U.S. Application Data
(60) Provisional application No. 61/371,964, filed on Aug. 9, 2010.

(51) Int. Cl. G06Q 30/00; G06N 5/02

(52) U.S. Cl. 705/14.53; 706/47

(57) ABSTRACT

A system, apparatus, and method for determining a consumer's location code/zip code based on data from payment transactions in which the consumer has participated. Payment transaction data for a consumer is processed to determine the location code/zip code corresponding to the locations in which the majority of transactions occurred. From this information, the most likely location code/zip code for the residence of the consumer is inferred. Based on the inferred location code/zip code for the consumer, demographic data may be accessed and used to infer characteristics of the financial situation or status of the consumer. Such financial situation or status information may include the average net worth, range of income, spending habits, etc. for a consumer residing in the identified location code/zip code. Based on the demographic data, products or services that may be of most interest to a person in the consumer's presumed financial situation may be marketed to the consumer.

### CROSS REFERENCE TO RELATED APPLICATIONS

This application claims priority from U.S. Provisional Patent Application No. 61/371,964, entitled “System And Method For Determining A Consumer's Zip Code From Payment Transaction Data,” filed Aug. 9, 2010, the contents of which are hereby incorporated in their entirety by reference for all purposes.

### BACKGROUND

Embodiments of the present invention are directed to systems, apparatuses and methods for enabling payment transaction processors (such as Visa) to more effectively develop and market their products and services to consumers. In some embodiments, this is achieved by identifying the location code (e.g., the zip code) of a consumer's residence (or another indicator of a consumer's location) from data for payment transactions in which the consumer has participated. More specifically, the present invention is directed to a system and method that process payment transaction data (and hence use actual spending behavior) to identify the probable location of the residence of a consumer who participated in the transactions. In some embodiments, this may be accomplished by determining or inferring a location code, zip code or other form of location identifier for the consumer's residence. Based on the results of this data processing, the probable location, location code, or zip code may be used in conjunction with other available demographic data (such as census data) to infer information about the consumer that might otherwise not be available to a payment processor. Such information may include the consumer's presumed level of affluence, educational level, net worth, or other potential indicators of a consumer's spending habits, interests, or likely interest in the services or products offered by the payment transaction processor. Such information concerning a consumer's financial situation or socio-economic status can be used by the payment processor or payment processing organization to direct marketing and product development efforts in a more effective manner. This may enable a payment processor to more effectively promote loyalty programs, incentive programs, new types of financial services, new types or features of payment devices, etc. to the desired audience.

Payment devices such as debit cards or credit cards are used by millions of people worldwide to facilitate various types of commercial transactions. These transactions generate a significant amount of transaction fees and processing fees, and as a result, a very competitive market exists for the issuance and management of payment devices and accounts. This has resulted in a large variety of payment devices, payment device features, pricing strategies, incentive programs for consumers, loyalty programs, and other features intended to differentiate an issuer's payment device or a payment processor's services in the marketplace, and to target specific intended users of the payment devices and services. One area in which this is important is in the targeting of products and services to a consumer based on the consumer's financial characteristics or socio-economic status, such as level of affluence, net worth, educational level, income level, etc. This is because a consumer's financial characteristics or socio-economic status are generally correlated with certain spending habits, and with their interest in certain types of products or services that may be provided by merchants, issuers of payment devices, or payment processors. These products or services may include loyalty programs, rewards programs, promotional offers for items of interest to those in the consumer's economic class, coupons, payment products having specific limits or benefits, etc.

In order to most effectively direct marketing and product development efforts at the intended audience, a payment processor or merchant (for example) may benefit from having a way to infer a consumer's financial characteristics or socio-economic status so they can use that information to determine which products or services could be most effectively marketed to that consumer. For example, a consumer's residence location (as represented, for example, by a location code or zip code) may serve as a proxy for certain aspects of the consumer's financial or socio-economic status, based on the assumption that people residing in that location have a net worth within a certain range, or share certain socio-economic characteristics. However, in some circumstances direct use of consumer location code or zip code data by a payment transaction processor may be prohibited because of consumer privacy concerns. For example, privacy concerns or regulations may prevent a payment processor or payment processing organization (such as Visa) from obtaining a consumer's location code or zip code from an issuer or other entity that has been provided the location code or zip code by the consumer.

What are desired are a system, apparatus and method for determining a consumer's location code or zip code, or other indicator of the location of the consumer's residence, based on data from payment transactions in which the consumer participated. Based on this information, the consumer's financial situation can be inferred from demographic data that is correlated with location, location code, zip code, or similar data. Once this is determined, marketing and product development activities can be more effectively directed at the intended audience. Embodiments of the invention address these problems and other problems individually and collectively.

### SUMMARY

Embodiments of the present invention are directed to a system, apparatus, and method for more effectively marketing financial products and services by determining the location of a consumer's residence (e.g., as represented by a location code, zip code, or other form of location identifier) based on data from payment transactions in which the consumer has participated. In some embodiments, payment transaction data for a consumer is processed to determine the location code or zip code, or location codes or zip codes corresponding to the locations in which the greatest number of qualifying transactions occurred. From this information, the most likely location code or zip code for the residence of the consumer is inferred. The payment transaction data may be pre-processed or filtered to select only certain types of transactions or only transactions involving certain merchant categories prior to performing the data processing used to infer the location code or zip code of the consumer. For example, only a transaction in which a consumer was face-to-face with a merchant (i.e., a card present transaction) may be considered as a qualifying transaction. Similarly, transactions involving certain types or categories of merchants may be excluded from the processing, such as lodging, auto rental, or airlines because the location codes or zip codes of the merchants involved in such transactions (even for card present transactions) are presumed to not be a reliable enough indicator of the location of the consumer's residence or the consumer's location code/zip code. Further, tests or conditions may be applied to ensure that the consumer location, location code, or zip code inferred by the invention has a desired degree of reliability, such as by requiring that a certain number of qualified transactions have occurred before using the transaction data to infer the location code/zip code. In addition, rules may be developed to determine the inferred location code/zip code in the case of ties (e.g., where more than one location code or zip code may be a candidate to represent the consumer's residence).

Based on the inferred location code/zip code for the residence of the consumer (or in some cases, another indicia of the location of the consumer's residence, such as a region or group of location codes/zip codes), census or other forms of demographic data may be accessed and used to infer characteristics of the financial situation or socio-economic status of the consumer. Such financial situation or socio-economic status information may include the average net worth, educational level, range of income, home ownership rates, disposable income, spending habits for certain types of goods or services, etc. for a consumer residing in the identified location code/zip code. Based on the census or demographic data, products or services that may be of most interest to a person in the consumer's presumed financial situation or socio-economic status may be marketed or promoted to the consumer.

Thus, once the inventive method has (hypothetically) determined the location code/zip code for a consumer's residence, that consumer's financial situation may be inferred by linking the presumed location code/zip code to census or other forms of demographic data. Based on the consumer's presumed financial situation or socio-economic status, marketing efforts may be more effectively directed at that consumer to ensure that the incentives, promotional materials, coupons, products, or services being offered to the consumer by a payment processor, merchant, or other party are those that are most likely to be accepted by the consumer. For example, based on a consumer's assumed level of income or likelihood of home ownership, financial services such as a reverse mortgage, estate planning, or a credit card with an associated home equity line might be offered to the consumer.

In one embodiment, the present invention is directed to an apparatus for determining a location code of the residence of a consumer, where the apparatus includes:
an electronic processor programmed to execute a set of instructions;
a data storage device coupled to the processor; and
the set of instructions contained in the data storage device, wherein when the set of instructions is executed by the processor, the apparatus determines the location code of the residence of the consumer by
   accessing payment transaction data for payment transactions involving the consumer;
   determining if the accessed payment transaction data satisfies a threshold criteria for further processing to determine the location code of the residence of the consumer;
   filtering the accessed payment transaction data to select a set of payment transaction data corresponding to card present transactions;
   filtering the set of payment transaction data corresponding to card present transactions to remove payment transaction data corresponding to transactions conducted with merchants having a specified set of merchant category codes;
   processing the remaining payment transaction data to determine a merchant location code for each transaction, the merchant location code corresponding to a location of a merchant that participated in each transaction;
   determining one or more of the merchant location codes that occur with the greatest frequency;
   applying a decision rule if more than one merchant location code occurs with the greatest frequency; and
   assigning the consumer residence location code to be the determined merchant location code that occurs with the greatest frequency or the outcome of applying the decision rule if more than one merchant location code occurs with the greatest frequency.

In another embodiment, the present invention is directed to a method of determining a location code of the residence of a consumer, where the method includes:
accessing payment transaction data for payment transactions involving the consumer;
determining if the accessed payment transaction data satisfies a threshold criteria for further processing to determine the location code of the residence of the consumer;
filtering the accessed payment transaction data to select a set of payment transaction data corresponding to card present transactions;
filtering the set of payment transaction data corresponding to card present transactions to remove payment transaction data corresponding to transactions conducted with merchants having a specified set of merchant category codes;
processing the remaining payment transaction data to determine a merchant location code for each transaction, the merchant location code corresponding to a location of a merchant that participated in each transaction;
determining one or more of the merchant location codes that occur with the greatest frequency;
applying a decision rule if more than one merchant location code occurs with the greatest frequency; and
assigning the consumer location code to be the determined merchant location code that occurs with the greatest frequency or the outcome of applying the decision rule if more than one merchant location code occurs with the greatest frequency.

In yet another embodiment, the present invention is directed to a method of marketing a product or service to a consumer, where the method includes:
accessing payment transaction data for an account associated with the consumer;
processing the accessed data to identify transaction data for one or more card present transactions;
processing the transaction data for the one or more card present transactions to remove data for transactions occurring at merchants associated with a specific merchant category code;
determining a location code associated with the greatest number of the one or more card present transactions not removed from the data;
assigning the determined location code to be a location code of the residence of the consumer;
using the assigned location code to access demographic data for residents residing in that location code;
using the accessed demographic data to infer information regarding the financial or socio-economic status of the consumer; and
based on the inferred financial or socio-economic status of the consumer, developing a marketing plan for the product or service directed to the consumer.

Other objects and advantages of the present invention will be apparent to one of ordinary skill in the art upon review of the detailed description of the present invention and the included figures.

### BRIEF DESCRIPTION OF THE DRAWINGS

FIG. 1 is a functional block diagram illustrating the primary functional elements of an exemplary system for conducting an electronic payment transaction and processing payment transaction data that may be used in implementing an embodiment of the present invention;

FIG. 2 is a functional block diagram further illustrating components of a payment processing network (or payment processing system) and elements that may interact with that network to enable a consumer to conduct a payment transaction, and as a result that may generate or process data used to implement a method for determining the location code/zip code of a consumer's residence, in accordance with some embodiments of the present invention;

FIG. 3 is a block diagram illustrating data sources that may be used in implementing a method for determining the location code/zip code of a consumer, in accordance with some embodiments of the present invention;

FIG. 4 is a flowchart illustrating a process or method for determining the location code/zip code associated with the residence of a consumer and based on that location code/zip code, marketing products or services to the consumer, in accordance with some embodiments of the present invention; and

FIG. 5 is a block diagram of elements that may be present in a computing device or system configured to execute a method or process in accordance with some embodiments of the present invention.

### DETAILED DESCRIPTION

Embodiments of the present invention are directed to a system, apparatus, and method for determining a location code, zip code, or other form of location identifier corresponding to the location of a consumer's residence based on data from payment transactions in which the consumer has participated. Further, in some embodiments, the present invention is directed to using the residence location code/zip code of the consumer to infer financial or socio-economic information about the consumer, and based on that information, to develop a plan for marketing services and products to the consumer.

In some embodiments of the invention, payment transaction data for a consumer's account is processed to determine the location code/zip code or location codes/zip codes corresponding to the locations in which the transactions occurred. The transactions may be associated with one or more issuers. From this information, the most likely location code/zip code for the residence of the consumer is inferred, such as by selecting the location code/zip code in which the greatest number of transactions occurred, or the location code/zip code in which the largest amount of money was spent. In some embodiments, the payment transaction data may be pre-processed or filtered to select only certain types of transactions or transactions involving certain merchant categories prior to performing the data processing used to infer the location code/zip code of the consumer. For example, only transactions in which a consumer was face-to-face with a merchant (i.e., card present transactions) may be considered. Similarly, transactions involving certain types or categories of merchants may be excluded from the processing (such as lodging, auto rental, or airlines) because the location code/zip code of the merchants involved in such transactions (even for card present transactions) are presumed to not be a sufficiently reliable indication of the consumer's home location or location code/zip code. Further, tests or conditions may be applied to ensure that the consumer location code/zip code inferred by the invention has a desired degree of reliability, such as by requiring that a certain number of qualified transactions have occurred before using the transaction data to infer the location code/zip code. In addition, rules may be developed to determine the inferred location code/zip code in the case of ties, such as where more than one location code/zip code may be a candidate to represent the location of the consumer's residence.

Based on the inferred location code/zip code for the residence of the consumer (or in some cases, another indicia of the location of the consumer's residence, such as a region or group of location codes/zip codes), census or other forms of demographic data may be accessed and used to infer characteristics of the financial situation or socio-economic status of the consumer. Such financial situation or socio-economic status information may include the average net worth, educational level, range of income, home ownership rates, disposable income, spending habits for certain types of goods or services, etc. for a consumer residing in the identified location code/zip code. Based on the census or demographic data, products or services that may be of most interest to a person in the consumer's presumed financial situation or socio-economic status may be marketed or promoted to the consumer.

Thus, once the inventive method has (hypothetically) determined a consumer's location code/zip code, that consumer's financial situation may be inferred by linking the presumed location code/zip code to census or other forms of demographic data. Based on the consumer's presumed financial situation or socio-economic status, marketing efforts may be more effectively directed at that consumer to ensure that the incentives, promotional materials, coupons, products, or services being offered to the consumer by a payment processor, merchant, or other party are those that are most likely to be accepted by the consumer.

In portions of the following description of one or more embodiments of the present invention (and the associated figures), reference will be made to a consumer's zip code, or to the zip code of a merchant or of the consumer's residence. It should be understood that although reference is made to a “zip code”, this is for purposes of example; embodiments of the present invention are directed to determining a location, location code, or other form of location identifier corresponding to a consumer's residence, where a zip code is an example of the more general concept of a location code or location identifier. Thus, in some countries or regions the location of a consumer's residence may be associated with a form of location code, where that location code may be termed a zip code in certain countries or regions. Use of the terminology “zip code” is meant as an example of a location code and is not intended to limit embodiments of the invention to any particular form of location code or location identifier.

Embodiments of the present invention are typically implemented in the context of a payment transaction system, and specifically, in the context of the processing of transaction data as part of account management functions performed by an entity that is part of a payment processing network. In some embodiments, such an entity may be a payment processor or payment processing organization, for example, Visa. In a typical payment transaction, an account owner (e.g., an individual consumer) provides a payment account or payment device identifier to a merchant or service provider. The payment account or payment device identifier may be provided in the form of a card (e.g., a magnetic stripe card or smart card with an embedded chip) accessed by a point of sale terminal or card reader, or by a contactless device embedded in a mobile device that communicates with a point of sale terminal using a near field communications technique, or by another suitable form.

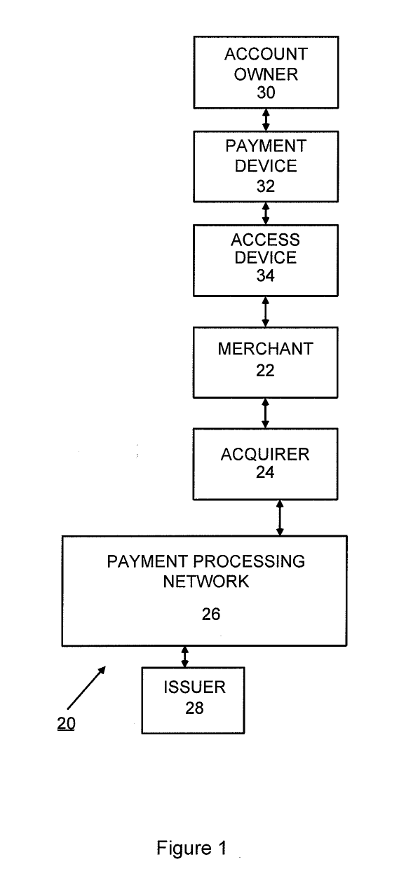

In order to provide a context in which the present invention may be implemented, a brief discussion of the entities involved in processing and authorizing a payment transaction and their roles in the processing of payment transaction data, will be presented. FIG. 1 is a functional block diagram illustrating the primary functional elements of an exemplary system 20 for conducting an electronic payment transaction and processing payment transaction data that may be used in implementing an embodiment of the present invention. Typically, an electronic payment transaction is authorized if the consumer (typically the account owner) conducting the transaction is properly authenticated (i.e., their identity and their valid use of a payment account is verified) and has sufficient funds or credit to conduct the transaction. Conversely, if there are insufficient funds or credit in the account, or if the payment device is on a negative list (e.g., it is indicated as possibly having been stolen), then an electronic payment transaction may not be authorized. In the following description, an “acquirer” is typically a business entity (e.g., a commercial bank) that has a business relationship with a particular merchant. An “issuer” is typically a business entity (e.g., a bank or credit union) which issues a payment device (such as a credit card, debit card, smart card, or contactless device) to an account owner and which provides administrative and management functions for the payment account. Some entities may perform both issuer and acquirer functions.

As shown in FIG. 1, in a typical transaction, a consumer/account owner 30 wishing to purchase a good or service from a merchant provides transaction data that may be used as part of a transaction authorization process, typically by means of a payment device 32. Account Owner 30 may utilize a payment device 32 such as a card having a magnetic stripe encoded with account data or other relevant data (e.g., a standard credit or debit card) to initiate the transaction. In an eCommerce (electronic commerce) transaction, the account owner may enter data into a device capable of communicating with a merchant or other element of system 20, such as a laptop or personal computer. The account owner may also initiate the transaction using data stored in and provided from a suitable form of data storage device (such as a smart card, mobile phone or PDA containing a contactless element, or a transportable memory device). As examples, a card or similar payment device may be presented to a point of sale terminal which scans or reads data from that card. Similarly, an account owner may enter payment account data into a computing device as part of an eCommerce transaction. Further, an account owner may enter payment account data into a cell phone or other device capable of wireless communication (e.g., a laptop computer or personal digital assistant (PDA)) and have that data communicated by the device to the merchant, the merchant's data processing system, or a transaction authorization network. A wireless device may also be used to initiate a payment transaction by means of communication between a contactless element embedded within the device and a merchant device reader or point of sale terminal by using a near field communications (NFC) or short range communications mechanism, such as RF, infra-red, optical, etc. Thus, in some cases an access device 34 may be used to read, scan, or otherwise interact with a payment device and thereby obtain data used in conducting a payment transaction.

The payment account data (and if needed for processing the transaction, other account owner data) is obtained from the account owner's device and provided to the merchant 22 or to the merchant's data processing system. The merchant or merchant's data processing system generates a transaction authorization request message that may include data obtained from the payment device as well as other data related to the transaction or to the merchant. As part of generating the authorization request message, the merchant 22 or the merchant's transaction data processing system may access a database which stores data regarding the account owner, the payment device, or the account owner's transaction history with the merchant. The merchant transaction data processing system typically communicates with a merchant acquirer 24 (e.g., a commercial bank which manages the merchant's accounts) as part of the overall transaction authorization process. The merchant's transaction data processing system and/or merchant acquirer 24 provide data to Payment Processing Network 26, which among other functions, participates in the clearance and settlement processes which are part of the transaction processing. Payment Processing Network 26 may be operated in whole or in part by a payment processing organization such as Visa. As part of the transaction authorization process, an element of Payment Processing Network 26 may access an account database which contains information regarding the account owner's payment history, chargeback or dispute history, credit worthiness, etc. Payment Processing Network 26 communicates with issuer 28 as part of the authorization process, where issuer 28 is the entity that issued the payment device to the account owner and provides administrative and management services for the consumer's payment account. Account data is typically stored in an account owner database which is accessed by issuer 28 as part of the transaction authorization and account management processes.

In standard operation, an authorization request message is created during a purchase (or proposed purchase) of a good or service at a point of sale (POS). The point of sale may be a merchant's physical location or may be a virtual point of sale such as a web-site that is part of an eCommerce transaction. In a typical transaction, the authorization request message is sent from the point of sale (e.g., the merchant or the merchant's transaction data processing system) to the merchant's acquirer 24, then to the Payment Processing Network 26, and then to the appropriate issuer 28. An authorization request message can include a request for authorization to conduct an electronic payment transaction. It may include one or more of an account owner's primary account number (PAN), payment device expiration date, currency code, sale amount, merchant transaction stamp, acceptor city, acceptor state/country, etc. An authorization request message may be protected using a secure encryption method (e.g., 128-bit SSL or equivalent) in order to prevent data from being compromised.

Payment device 32 may be in any suitable form and may incorporate a contactless chip or other element that facilitates payment transactions. For example, suitable payment devices can be hand-held and compact so that they can fit into a wallet and/or pocket (e.g., pocket-sized). They may include contact or contactless smart cards, credit or debit cards (typically with a magnetic stripe and without an embedded microprocessor), keychain devices (such as the Speedpass™ which is commercially available from Exxon-Mobil Corp.), and depending upon the specific device, may incorporate a contactless element that is configured to enable the device to participate in payment transactions. Other examples of suitable payment devices include cellular phones, personal digital assistants (PDAs), pagers, payment cards, security cards, access cards, smart media, transponders, and the like, where such devices may incorporate a contactless element. Depending upon the specific design, the payment device may function as one or more of a debit device (e.g., a debit card), a credit device (e.g., a credit card), or a stored value device (e.g., a stored value or prepaid card).

Payment Processing Network 26 may include data processing subsystems and networks, and may be configured to implement operations used to support and deliver authorization services, exception file services, and clearing and settlement services. An exemplary payment processing network may include VisaNet. Payment processing networks such as VisaNet are able to process credit card transactions, debit card transactions, and other types of commercial transactions. VisaNet, in particular, includes a VIP system (Visa Integrated Payments system) which processes authorization requests for transactions and a Base II system which performs clearing and settlement services for transactions.

Payment Processing Network 26 may include a server computer. A server computer is typically a powerful computer or cluster of computers. For example, the server computer can be a mainframe, a minicomputer cluster, or a group of servers functioning as a unit. In one example, a server computer may be a database server coupled to a Web server. Payment Processing Network 26 may use any suitable wired or wireless network, including the Internet, to facilitate communications and data transfer between its component system elements.

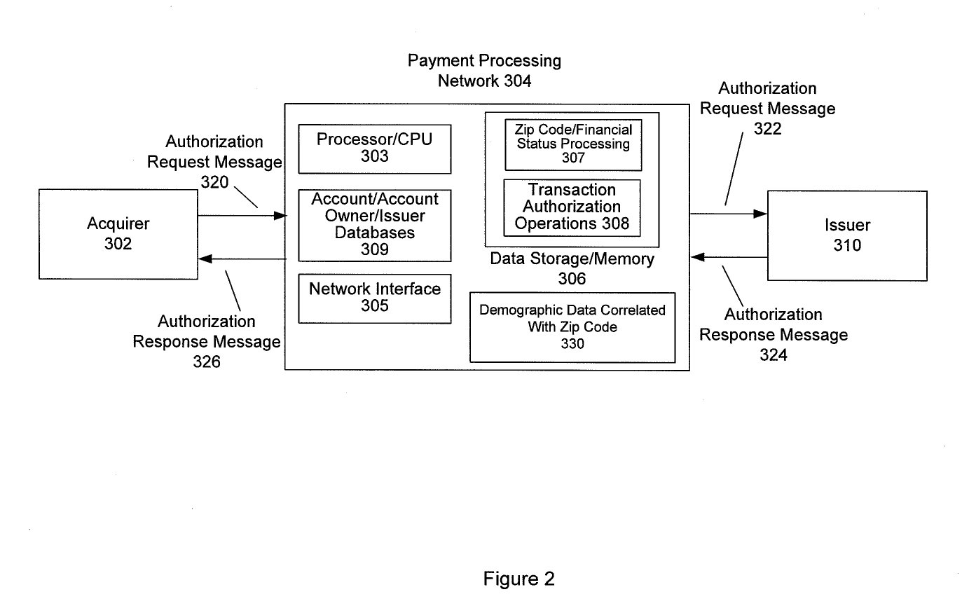

FIG. 2 is a functional block diagram further illustrating components of a payment processing network (or payment processing system) and elements that may interact with that network to enable a consumer to conduct a payment transaction, and as a result that may generate or process data used to implement a method for determining the location code/zip code of a consumer, in accordance with some embodiments of the present invention. As shown in the figure, elements that interact with network 304 include an acquirer 302 which provides an authorization request message 320 for a payment transaction to payment processing network 304. Payment processing network 304 may provide a processed authorization request message 322 to issuer 310 to assist issuer 310 in deciding whether to authorize or deny a transaction. Issuer 310 provides payment processing network 304 with an authorization response message 324 containing an indication of whether the transaction has been approved or denied. Authorization response message 326 (which may be the same as message 324, or may contain other information) is provided to acquirer 302 to inform acquirer 302 (and ultimately the merchant and account owner) if the transaction has been approved or denied.

In processing the transaction authorization messages, processing other data related to payment transactions, or processing records relating to the processing of payment transaction data by other entities in order to implement the inventive processes or methods, payment processing network 304 may utilize one or more of the components or elements depicted in FIG. 2. Such components or elements include a processor or central processing unit 303 that is programmed to execute a set of instructions, where some or all of those instructions may be stored in data storage device or memory 306. The instructions may include instructions which when executed, cause payment processing network 304 (e.g., a server or data processing apparatus that is part of network 304) to perform one or more payment transaction data processing functions or operations (as suggested by instructions or instruction set 308) and/or functions or operations used to infer the location code/zip code of a consumer (and from the inferred location code/zip code, to determine certain of the financial characteristics of the consumer, as suggested by instructions or instruction set 307). In performing these operations, processor or central processing unit 303 may access one or more databases 309 containing transaction and account data and information. Central processing unit 303 may also access census and/or other forms of demographic data that are indexed by or correlated with location code/zip code and which may be part of databases 309, or may be provided by another source, such as data source 330. Note that data source 330 may be data stored within a component of payment processing network 304 (as suggested by the figure) or may be a data source that is external to the components of payment processing network 304 and which is accessible by processing unit 303 by virtue of a suitable data transfer mechanism such as a communications network.

The transaction data, account data, and census and/or other forms of demographic data are used by payment processing network 304 to infer the residence location code/zip code of a consumer and to thereby infer or determine information related to the financial characteristics or socio-economic status of the consumer. Such financial characteristics or socio-economic status information may include, but are not limited to, net worth, range of income, disposable income, educational level, credit rating, spending habits, expected debt, rate of home ownership, etc. Such financial characteristics or status information may then be used to more effectively direct marketing or promotional activities for goods or services to the intended audience. Payment processing network 304 may utilize network interface 305 to enable communication with other elements depicted in FIG. 2.

As recognized by the inventors, Visa and other non-bank payment processors such as payment processing systems, payment processing organizations, or payment processing networks can only capture consumer information as it relates to a transaction. For example, a payment processor may have access to the card number, merchant location, and the amount involved in a transaction but will typically not be able to capture certain information about a consumer that is normally available to the issuer of a payment device. Specifically, the consumer's/cardholder's residence location code/zip code is typically not available from the transaction data, but may be an important indicator of a consumer's financial status and one that is normally used by issuers to profile cardholders. Payment processors or payment processing organizations such as Visa are normally unable to capture data indicating where a consumer/cardholder lives because the information is not provided as part of the transaction. In addition, even if such information is provided as part of the transaction or is otherwise available (for example, where a location code/zip code is provided as part of an authentication or identification process), actual consumer location code/zip code data is generally not permitted for use in marketing purposes because of privacy concerns. In response to this situation, the inventors recognized that use of a derived location code/zip code based on an analysis of transaction data could provide a solution while addressing the issues raised by using actual consumer location code/zip code information. A payment processor (such as a payment processing organization or operator of a payment processing network) wanting to segment cardholders or use indicators of wealth or socio-economic status to focus marketing or product design efforts may use the present invention to infer the location code/zip code of a consumer's residence and the financial status of a consumer, and in response to develop a marketing program based on that information.

The location code/zip code determining system and method of the present invention uses actual transaction data (obtained from purchases at merchant locations, and which may include transactions conducted using payment devices from multiple issuers) to derive the probable or most likely residence location code/zip code of a consumer. Using the inferred location code/zip code for the residence of a consumer, the invention matches the consumer/cardholder to census and other data that is indexed by (or otherwise associated with) location code/zip code, and thereby maps the location code/zip code based demographic characteristics to the consumer. This is used to imply a consumer's socio-economic status such as level of affluence, net worth, spending habits, likely debt, disposable income, desired financial or estate planning services, etc. as well as other characteristics that can be used to provide a deeper understanding of the consumer's spending behavior or need for financial services. As noted, the use of merchant acquired transaction information avoids privacy concerns that might arise from the use of actual consumer location code/zip code information for these purposes.

In some embodiments of the invention, the payment transaction data selected for processing in order to determine the location code/zip code of a consumer's residence is selected by first identifying those consumers or accounts that satisfy one or more threshold criteria. The threshold criteria may be based on one or more relevant factors, such as for example: (1) the consumer or account participating in a specified number of payment transactions within a specified time period; (2) the consumer or account participating in a specified number of card present (face-to-face) transactions within a specified time period; (3) the consumer or account participating in a specified number of relatively high value transactions within a specified time period, etc. Further, for those consumers or accounts that satisfy the threshold criteria, one or more data filters may be applied to the payment transaction data for the account in order to select only certain of the transaction data for processing to infer the consumer residence location code/zip code. For example, only card present transactions may be selected. In another example, only card present transactions occurring during an evening or weekend may be selected, as the location(s) for such transactions are presumed to be more closely associated with a consumer's neighborhood or residence. Other filters or criteria may be applied as desired to select the transaction data used for determining a consumer's residence location code/zip code, with it being understood that the accuracy of the location code/zip code so determined may depend upon the filters or criteria being used.

As noted, in some embodiments or implementations of the invention, a consumer's transaction activities may be required to satisfy a specified threshold or criteria to be used as the basis for inferring the consumer's residence location code/zip code. This may be done to increase the reliability of the location code/zip code determined by the invention. For example, each cardholder for which a residence location code/zip code is to be determined by the invention may be required to have participated in at least ten transactions in a 12-month period (or another threshold number of transactions) in order to be associated with an imputed location code/zip code. In another example, each cardholder for which a residence location code/zip code is to be determined by the invention may be required to have participated in at least a specified number (e.g., ten) of face-to-face or card present transactions in order to be associated with an imputed location code/zip code. The use of face-to-face or card present transactions was found by the inventors to provide more reliable location code/zip code determinations. This is because the location code/zip code associated with a merchant involved in such a transaction is more likely to represent that of the consumer than would the location code/zip code of a merchant involved in an eCommerce transaction, for example. Thus, by requiring that the transaction data used to infer the location code/zip code be based on card present transactions (as may be determined by a ECI-Moto code or other form of transaction data), the present invention eliminates use of data from transactions that are expected to be less closely associated with a consumer's residence location code/zip code.

In addition to using card present transaction data, in some embodiments, the inventors applied one or more filters to remove or exclude the use of data from transactions that were expected to have occurred outside of a consumer's residential area, or were less likely to be indicative of a consumer's residential location code/zip code. For example, certain travel related transactions would typically be expected to have occurred outside of a consumer's residential location code/zip code (or at least be a less reliable indicator of a consumer's residence location code/zip code), and so transactions occurring at merchants having a merchant category code (MCC) corresponding to travel related industries or functions may be excluded from use in determining the consumer's residential location code/zip code. Another example is to use a filter to select only those transactions occurring at night or on weekends as these would be expected to have occurred at a merchant that was more likely to be located near the consumer's residence. In general, one or more filters or sorting mechanisms may be used that (1) include or preferentially select transactions most likely to occur at a merchant located in the same location code/zip code as the consumer; and/or (2) exclude transactions most likely to occur at a merchant in a location not associated with a consumer's residence (or transactions whose location is less reliably associated with a consumer's residence).

For example, in one embodiment of the invention, the inventors determined that the MCC codes contained in the following Market Segments (i.e., merchant category codes (MCC), where multiple such codes may be rolled up into the indicated Market Segment Categories, such as “Department Stores”, etc.) would be reliable as indicators of transactions conducted at merchants expected to be located near a consumer's residence (where as noted, each market segment category may contain multiple MCC codes):

### Bill Pay

### Department Stores

### Direct Marketing

### Discount Stores

### Drug Stores & Pharmacies

Furniture/Equip. Stores

### Health Care

Misc. Specialty Retail

### Oil

### Other Emerging

### Other Retail

QSR's (quick service restaurants)

### Radio TV & Stereo Stores

### Restaurants

### Sporting Goods Stores

### Supermarkets

### Toll And Bridge Fees

### Wholesale Clubs

Note that the categories or market segments listed represent general classifications and are intended for purposes of example. Different payment processing organizations or networks may use different classification methods, names, labels, or categories to represent transactions falling within the indicated market segment categories, and implementation of the present invention is not limited to any one set or group of such classifications, etc.

As an example, the table below (labeled “Table 1”) shows merchant category segment names (such as “Airlines” or “Auto Rental”) and possible merchant codes and corresponding members of those categories that might be used by a payment processing organization or network. The category names and example members are provided for purposes of illustration with the understanding that other groupings are possible and may be used by other payment processing organizations or networks without departing from the underlying concepts of the present invention.

TABLE 1

| | | |
|---|---|---|
| AIRLINES | 3000 | UNITED |
| | 3001 | AMERICAN |
| | 3063 | US AIRWAYS |
| AUTO RENTAL | 3357 | HERTZ RENT-A-CAR |
| | 3366 | BUDGET RENT-A-CAR |
| | 3389 | AVIS RENT-A-CAR |
| BILL PAY | 4814 | TELECOMMUNICATION SERVICES |
| | 4816 | COMPUTER NETWORK/INFO SVCS |
| | 4899 | CABLE, SAT, PAY TV/RADIO SVCS |
| BUSINESS TO BUSINESS | 4214 | MOTOR FREIGHT CARRIERS |
| | 5039 | CONSTRUCTION MATERIALS - DEF |
| | 5045 | COMPUTERS/PERIPHERALS/SOFTWARE |
| DEPARTMENT STORES | 5311 | DISCOUNT STORES |
| DIRECT MARKETING | 5964 | CATALOG MERCHANT |
| | 5966 | OUTBOUND TELEMARKETING |
| | | MERCHANT |
| | 5969 | OTHER DIRECT MARKETERS |
| DISCOUNT STORES | 5310 | DISCOUNT STORES |
| DRUG STORES & | 5912 | DRUG STORES & PHARMACIES |
| PHARMACIES | | |
| FURNITURE/EQUIP. | 5712 | FURNITURE/EQUIP STORES |
| STORES | | |
| GOVERNMENT | 8211 | ELEMENTARY/SECONDARY SCHOOLS |
| | 8220 | COLLEGES/UNIV/JC/PROFESSION |
| | 9211 | COURT COSTS/ALIMONY/SUPPORT |
| HEALTH CARE | 4119 | AMBULANCE SERVICE |
| | 742 | VETERINARY SERVICES |
| | 8021 | DENTISTS/ORTHODONTISTS |
| LODGING | 3501 | HOLIDAY INN |
| | 3504 | HILTON |
| | 3513 | WESTIN |
| MISC. SPECIALTY RETAIL | 5999 | MISC. SPECIALTY RETAIL |
| OIL | 5541 | SERVICE STATIONS |
| | 5542 | AUTOMATED FUEL DISPENSERS |
| OTHER EMERGING | 4111 | LOCAL COMMUTER TRANSPORT |
| | 7523 | PARKING LOTS, METERS, GARAGES |
| | 7832 | MOTION PICTURE THEATRES |
| OTHER RETAIL | 1711 | HEATING, PLUMBING, AIR COND |
| | 5200 | HOME SUPPLY WAREHOUSE STORES |
| | 5533 | AUTOMOTIVE PARTS STORES |
| OTHER TRAVEL & | 4131 | BUS LINES |
| ENTERTAINMENT | | |
| | 4582 | AIRPORTS/FIELDS/TERMINALS |
| | 5813 | BARS/TAVERNS/LOUNGES/DISCOS |
| QSR'S | 5814 | FAST FOOD RESTAURANTS |
| RADIO TV & STEREO | 5732 | ELECTRONICS STORES |
| STORES | | |
| REMAINING MERCHANTS | 4112 | PASSENGER RAILWAYS |
| | 5422 | FREEZER/MEAT LOCKERS |
| | 5963 | DIRECT SELL/DOOR-TO-DOOR |
| RESTAURANTS | 5812 | RESTAURANTS |
| SPORTING GOODS | 5941 | SPORTING GOOD STORES |
| STORES | | |
| STEAMSHIP/CRUISE LINES | 4411 | STEAMSHIP/CRUISE LINES |
| SUPERMARKETS | 5411 | GROCERY STORES/SUPERMARKETS |
| TOLL AND BRIDGE FEES | 4784 | TOLLS AND BRIDGE FEES |
| TRAVEL AGENCIES | 4722 | TRAVEL AGENCIES |
| WHOLESALE CLUBS | 5300 | WHOLESALE CLUBS |

Similarly, the inventors determined that embodiments or implementations of the present invention may provide more reliable results by effectively ignoring transactions conducted at merchants in the following Market Segments (which again may represent or include a set of corresponding merchant category codes or groups of codes), as these were expected to have a less significant correlation with, or be less indicative of, a consumer's residence location code/zip code:

### Airlines

### Auto Rental

### Business To Business

### Government

### Lodging

### Other Travel & Entertainment

### Remaining Merchants

### Steamship/Cruise Lines

### Travel Agencies

As before, note that the categories or market segments listed represent general classifications and are intended for purposes of example. Different payment processing organizations or networks may use different classification methods, names, labels, or categories to represent transactions falling within the indicated market segment categories, and implementation of the present invention is not limited to any one set or group of such classifications, etc.

Thus in one embodiment of the invention, transactions from certain market segments (and hence certain merchant category codes) may be included in the processing to infer a consumer's residential location code/zip code, while transactions from specific merchant category codes may be excluded (e.g., a “white list” and “black list” based approach). In another embodiment of the invention, transactions from market segments (and hence merchant category codes) that are expected to not be a reliable indicator of a consumer's residential location (such as transactions occurring during travel) may be excluded, with all other transactions (and hence merchant category codes) included as part of the inventive data processing. Note that a sensitivity analysis may be used to determine which of these or other possible data processing methodologies is preferable and yields the most accurate and consistent results. Such a sensitivity analysis may operate to compare the inferred location code/zip code of the residence of a consumer with the actual location code/zip code as obtained from another source. This may be used to determine if the inventive method has generated a location code/zip code that is either the same as the consumer's actual location code/zip code or is representative of the same or a similar socio-economic class as the consumer's residence location code/zip code.

In one embodiment, a consumer's residence location code/zip code may be determined (or more precisely, inferred) by identifying the location code/zip code where face-to-face purchases in the identified categories (or in those merchant categories or market segments not removed from consideration) are made most frequently. That is, the most frequently occurring location code/zip code in which face-to-face purchases are made in the identified categories is assumed to be the consumer's residence location code/zip code. In the event of a result where two or more location code/zip codes have the highest number of qualifying purchases made, a tie breaking mechanism may be applied (such as using the location code/zip code with the higher spending amount as the assumed consumer residence location code/zip code).

Note that other heuristics may be used to determine the location code/zip code that most likely corresponds to the residence of the consumer. For example, the merchant location code/zip code in which only certain types of transactions (such as purchases of gasoline or shopping for food) are made most frequently might be identified as the likely location code/zip code of the consumer's residence. Similarly, in the case of more than one location code/zip code being the most frequently occurring merchant location code/zip code, the location code/zip code that includes merchants falling within certain categories (such as gas stations or food markets) might be selected as the consumer residence location code/zip code instead of selecting the location code/zip code having the greatest amount of spending. Further, in some cases, instead of determining a single location code/zip code, the inventive method may be used to determine a region or set of location codes/zip codes in which a consumer is most likely to reside. This may be accomplished by processing transaction data to identify a set or group of location codes/zip codes in which a majority of qualifying transactions occurred. For example, if the number of transactions occurring in the most common merchant location code/zip code does not provide a sufficiently large sample to reliably indicate the consumer's residence location code/zip code, then a larger set of transactions (and hence possible location codes/zip codes) may be considered. If this larger set of location codes/zip codes defines a relatively contiguous region, then in some embodiments the consumer may be presumed to reside within that region. If the financial characteristics or socio-economic status of residents of the region do not vary significantly within the region, then the characteristics or status of a resident of a location code/zip code falling within the region may be taken to be representative of the consumer.

Based on the location code/zip code assumed for the consumer's residence, demographic data that is associated with location code/zip code may be accessed to provide information about the consumer that is relevant to determining the consumer's possible interest in certain financial products or services. Such demographic data may include, but is not limited to, census data, marketing studies, consumer behavior studies, consumer spending data, Internal Revenue Service data, educational or wealth data, etc. Potentially relevant information about a consumer that may be obtained from such demographic data may include, but is not limited to, income levels, net worth, disposable income, estate planning or retirement account data, educational levels, spending habits, expected debt amounts, likelihood of home ownership, products or services that may be of interest, etc. Based on the financial, educational, spending, or other characteristics that are associated with a consumer based on the consumer's assumed residence location code/zip code, product development, marketing of products and services, and other promotional efforts may be more effectively directed at the consumer.

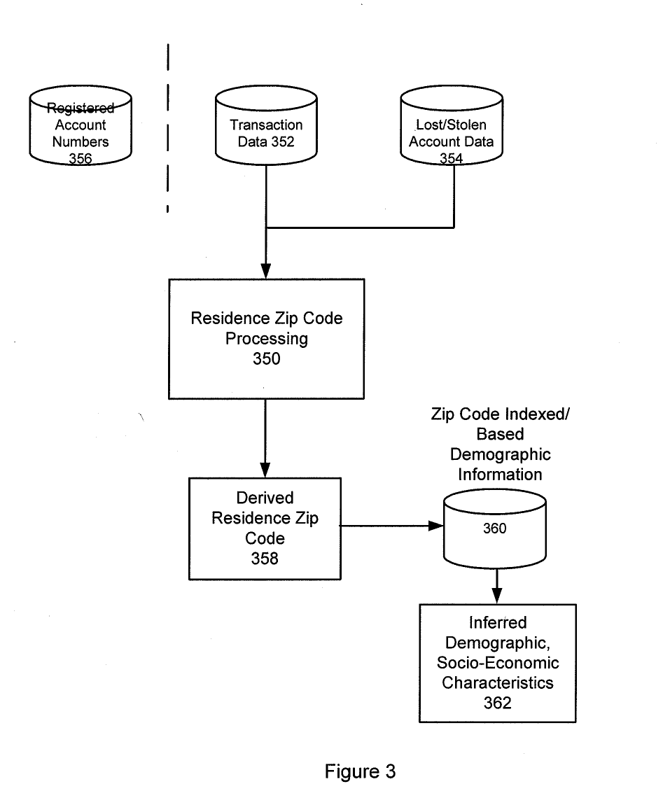

FIG. 3 is a block diagram illustrating data sources that may be used in implementing a method for determining the location code/zip code of a consumer, in accordance with some embodiments of the present invention. As shown in the figure, in one embodiment, a data processing element processes input data to derive a zip code that is assumed to represent or be associated with a consumer's residence (with these operations identified as “Residence Zip Code Processing 350” in the figure). This data processing element may be implemented as a suitably programmed processor, microprocessor, server, or other computing device capable of executing a set of instructions or software code that when executed, implements the present invention's method, operations and processes. For example, this data processing element may be processor/CPU 303 of FIG. 2 which may be programmed with a set of executable instructions (such as those identified by “Zip Code/Financial Status Processing 307” of FIG. 2). When executed, the instructions cause the data processing element to process payment transaction data to determine a consumer's presumed residential location code/zip code. Note that the payment transaction data may be derived from transactions in which one or more payment devices were used, with such payment devices being issued by one or more issuers.

The input data for Residence Zip Code Processing 350 may include, but is not limited to, Transaction Data 352, which typically includes transaction descriptions, the account number used for a transaction, the merchant that was a party to a transaction, the location code/zip code of the merchant, a category or other descriptive code identifying the type of merchant (such as the previously mentioned merchant category codes), a code from which it may be determined if the transaction was a face-to-face transaction, etc. Transaction Data 352 may be processed to identify all transactions associated with a particular account number or identifier. In order to obtain a complete transaction history for a consumer, it may be necessary to determine if a consumer's account number was changed as a result of a lost or stolen account number or payment device. For example, if a consumer's account number was stolen, then they would be issued a new account number. Therefore, in order to obtain a complete history of all transactions in which the consumer participated, Lost/Stolen Account Data 354 may be accessed to check if a particular account number was reported lost or stolen, and hence replaced. If so, then the transaction data for the new account number may be accessed and appended to that of the original account number in order to ensure that all transactions in which the consumer participated are taken into consideration.

Although in some cases a database may exist that contains account number data and the associated consumer location code/zip code or other private data (such as that identified by “Registered Account Numbers 356” in the figure), typically, due to consumer privacy regulations, consumer location code/zip code or other private data is not available to a payment processing network or organization for purposes of marketing products or services. This is one of the motivations behind the present invention; a desire to determine the likely residential location code/zip code of a consumer without accessing private or otherwise restricted data.

The input data is processed to determine a location code/zip code that is assumed to represent the residence location code/zip code of a consumer that is associated with an account number (identified as “Derived Residence Zip Code 358” in the figure). This data may be stored as a field in a database in which a consumer is associated with his or her account number or numbers and with the location code/zip code, or in another suitable format. Based on the derived location code/zip code, other data that is indexed by, or associated with, a residence location code/zip code (such as demographic data identified as “Zip Code Indexed/Based Demographic Information 360” in the figure) is accessed and processed. The data processing is used to determine one or more presumed socio-economic or other demographic characteristics of a person residing in the determined location code/zip code (identified as “Inferred Demographic, Socio-Economic Characteristics 362” in the figure). The socio-economic and other demographic data may then be used to more effectively market products and services (or other promotional activities) to the consumer by determining those products or services that are most likely to be of interest to a person having the inferred socio-economic or demographic characteristics.

Note that another potential source of data that may be used for determining (or inferring) the location code/zip code of a consumer's residence is the data records for the transaction authorization processes that are part of a payment transaction. For example, if a transaction is not authorized or approved by an issuer, then the resulting data record may contain information about the consumer's residence (or about a location code/zip code that does not correspond to the consumer's residence).

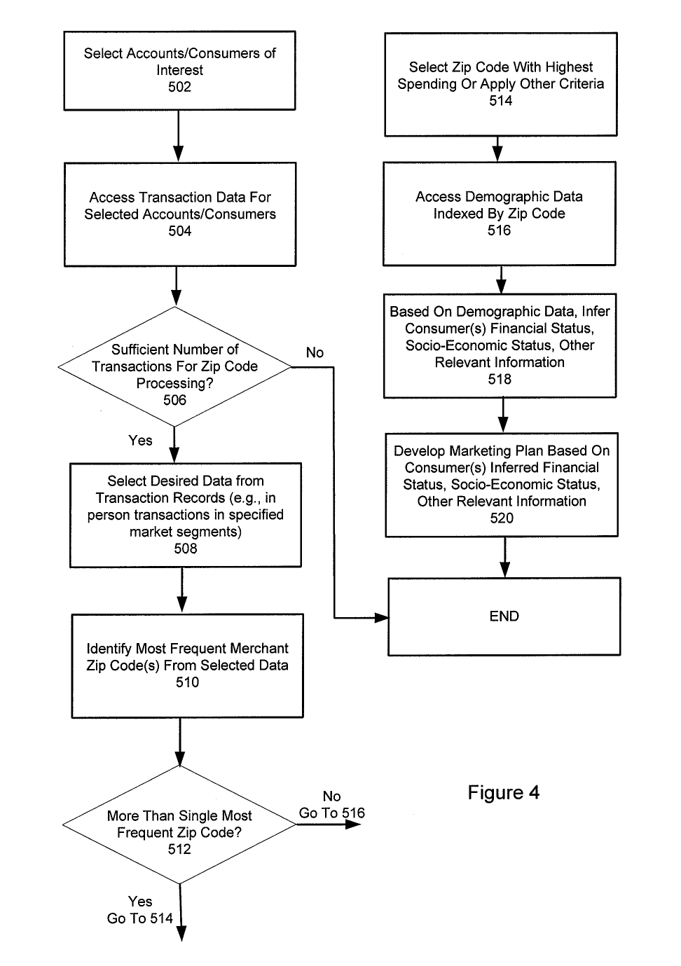

FIG. 4 is a flowchart illustrating a process or method for determining the location code/zip code associated with the residence of a consumer and based on that location code/zip code, marketing products or services to the consumer, in accordance with some embodiments of the present invention. The operations, method steps, and processes described with reference to FIG. 4 may be implemented by a suitably programmed computing device or data processing element. An example of such a computing device or data processing element would be a server or programmed computer that was part of payment processing network 26 of FIG. 1, such as processor/CPU 303 of FIG. 3.

As shown in the figure, a consumer or consumers of interest are first selected (stage 502). This may be done by selecting one or more account numbers for which it is desired to determine a residence zip code of the account owner or consumer (where as noted, the term “zip code” is used for purposes of an example, and is intended to represent the more general concept of a location code or location identifier). At stage 504, transaction data is accessed for the account or accounts of interest. As mentioned, because an account may be compromised or a payment device lost or stolen, a database of lost/stolen accounts may be accessed to obtain a more complete history of the transactions in which an account owner participated. The transaction data may include transaction descriptions, the account number used for a transaction, the merchant that was a party to a transaction, the zip code of the merchant's location, a merchant category code or other descriptive code identifying the type of merchant, a code from which it may be determined if the transaction was a face-to-face transaction, etc.

In one embodiment, for each of the selected accounts it is determined (at stage 506) if the number of transactions for that account are sufficient for processing to determine a residence zip code associated with the account. These criteria may be expressed in terms of a requirement of a certain number (e.g., ten) of transactions within a year, a certain number of transactions (e.g., five) within a specified time frame, a certain number of face-to-face transactions occurring within a specified time frame, etc. The criteria provide a form of data reliability check or threshold condition. This is because if the number of transactions (or a type of transaction, such as card present transactions) within a specific time frame falls below a specified threshold, there may not be sufficient data to provide a reliable indication of where a consumer most commonly engages in transactions (and hence where it is assumed that the consumer resides). Note that this filtering or threshold check may be performed at different stages of the overall processing, such as after the face-to-face transactions for certain merchant categories have been selected from the set of transaction data (thereby performing the zip code determination on the data only if the number of face-to-face transactions within the specified merchant categories satisfies a threshold value). If the number of transactions is not sufficient (the “No” branch) or the threshold check is not satisfied, then processing ends (as indicated by the path connecting the “No” branch of stage 506 to “END”).

If the number of transactions is sufficient (or the threshold check is otherwise satisfied), then processing continues to stage 508 where the desired data is selected from the transaction records. This may be accomplished by application of one or more data filters that operate to select a subset of the available data for processing. Such filters may select, for example, data corresponding to face-to-face transactions for merchants in specific categories, data indentifying the merchants which participated in such transactions, the location code/zip code of each such merchant, the category code (e.g., the MCC) or descriptor for each such merchant, etc. Note that examples of the category codes that may be selected for inclusion or exclusion have been described and may be used as the basis for constructing the desired data filters or filtering operations. At stage 510, the zip code or zip codes (or other suitable form of region or location identifier or code) that most frequently occur in the selected transaction data are determined. That is, the data processing determines the zip code or zip codes in which the most transactions occur (for example, by determining the zip code or codes for the merchants at which transactions occur and then determining the most frequently occurring zip code or codes).

Next, at stage 512 it is determined if there is more than a single most frequent zip code (which may result, for example, if a consumer regularly conducts transactions in more than one local region, such as a home residence region and a work location region). If there is only a single most frequently occurring zip code (the “No” branch), then processing continues to stage 516. If there is more than one most frequently occurring zip code (the “Yes” branch), then processing continues to stage 514 where a tie breaking mechanism is applied (such as by selecting the zip code associated with the highest amount of spending to be the assumed residence zip code). Note that other heuristics, criteria, or decision methods may be used at stage 514 to determine which of two or more zip codes should be assumed to be the zip code of a consumer's residence (and thus function as a tie-breaking mechanism or decision rule). Such heuristics, criteria, or decision methods may be based on other transaction characteristics, for example associations between certain types of transactions (two or more transactions that would typically be associated with merchants near a consumer's residence, such as grocery shopping and gasoline purchases), the timing of certain transactions (transactions expected to occur near a consumer's residence because of the time of the transaction), etc.

At stage 516, the assumed zip code for a consumer's residence is used to access demographic data, where that data is indexed by or otherwise associated with zip code. Such demographic data may include, but is not limited to, census data, income level data, Internal Revenue Service data, disposable income data, mortgage loan data, educational level data, spending habit data, data reflecting interest in specific goods, services, or activities, etc. For example, the presumed residence zip code may be used as an entry point to access data regarding the income level or educational level associated with consumers who reside in the specified zip code. At stage 518, the accessed data is used to infer one or more of the consumer's income, educational level, net worth, spending habits, potential interest in specific goods or services (such as financial planning or retirement planning), amount of disposable income, home ownership status, or other socio-economic indicators, etc. Based on this, a marketing plan can be developed to market products or services, offer promotions, suggest new payment products, offer loyalty programs or similar activities, etc. to a consumer that are expected to be of interest to that consumer (stage 520). Further, the information about a consumer's financial status or socio-economic status that is inferred using the described method may be used to assist in product development efforts that are designed to develop products or services expected to be of value to the consumer or to similarly situated consumers.

The described invention provides a system, apparatus, and method for determining the location code/zip code (or other form of location identifier) of a consumer's residence from payment transaction data for transactions in which the consumer has participated. The determined or inferred location code/zip code is used to access demographic or socio-economic data relevant to persons living in that location code/zip code. The demographic or socio-economic data is assumed to apply to the consumer and is then used to determine which products, services, loyalty programs, etc. may be of interest to the consumer. In this way the products or services of greatest potential interest to the consumer can be most effectively marketed to the consumer. The present invention provides a way to determine the consumer location code/zip code (and to develop a marketing plan directed to the consumer) without accessing individual location code/zip code data which may be restricted due to privacy concerns or other regulations.

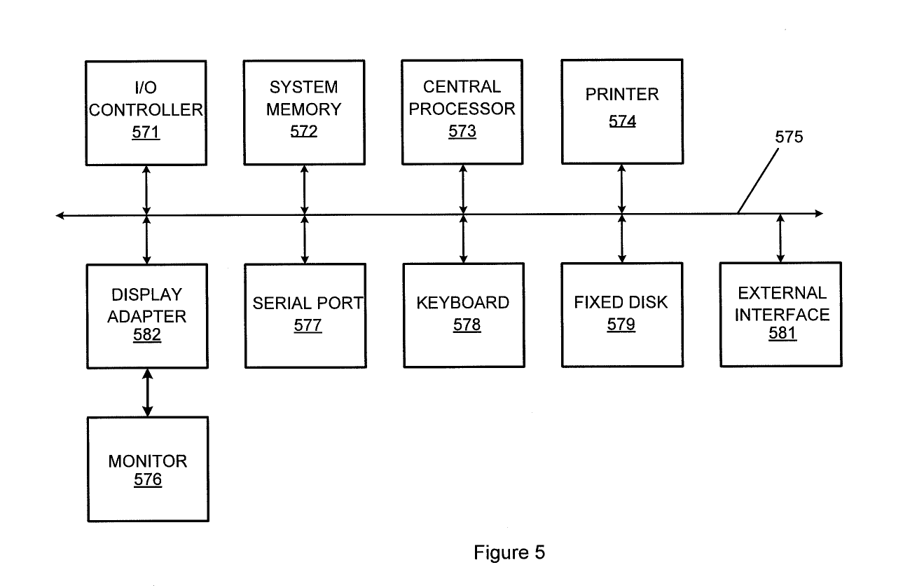

As noted, in some embodiments, the inventive methods, processes or operations may be wholly or partially implemented in the form of a set of instructions executed by a suitably programmed central processing unit (CPU) or microprocessor. The CPU or microprocessor may be incorporated in an apparatus, server or other data processing device operated by, or in communication with, a node of the transaction authorization network (such as a payment processor or element of a payment processing network 26 of FIG. 1, or processor/CPU 303 of FIG. 2). As an example, FIG. 5 is a block diagram of elements that may be present in a computing device or system configured to execute a method or process in accordance with some embodiments of the present invention. The subsystems shown in FIG. 5 are interconnected via a system bus 575. Additional subsystems such as a printer 574, a keyboard 578, a fixed disk 579, a monitor 576, which is coupled to a display adapter 582, and others are shown. Peripherals and input/output (I/O) devices, which couple to an I/O controller 571, can be connected to the computing system by any number of means known in the art, such as a serial port 577. For example, the serial port 577 or an external interface 581 can be used to connect the computing device to a wide area network such as the Internet, a mouse input device, or a scanner. The interconnection via the system bus 575 allows a central processor 573 to communicate with each subsystem and to control the execution of instructions that may be stored in a system memory 572 or the fixed disk 579, as well as the exchange of information between subsystems. The system memory 572 and/or the fixed disk 579 may embody a computer readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

As used herein, the use of “a”, “an” or “the” is intended to mean “at least one”, unless specifically indicated to the contrary.

What is claimed is:

1. An apparatus for determining a location code of the residence of a consumer, comprising:
an electronic processor programmed to execute a set of instructions;
a data storage device coupled to the processor; and
the set of instructions contained in the data storage device, wherein when the set of instructions are executed by the processor, the apparatus determines the location code of the residence of the consumer by
accessing payment transaction data for payment transactions involving the consumer;
determining if the accessed payment transaction data satisfies a threshold criteria for further processing to determine the location code of the residence of the consumer;
filtering the accessed payment transaction data to select a set of payment transaction data corresponding to card present transactions;
filtering the set of payment transaction data corresponding to card present transactions to remove payment transaction data corresponding to transactions conducted with merchants having a specified set of merchant category codes;
processing the remaining payment transaction data to determine a merchant location code for each transaction, the merchant location code corresponding to a location of a merchant that participated in each transaction;
determining one or more of the merchant location codes that occur with the greatest frequency;
applying a decision rule if more than one merchant location code occurs with the greatest frequency; and
assigning the consumer residence location code to be the determined merchant location code that occurs with the greatest frequency or the outcome of applying the decision rule if more than one merchant location code occurs with the greatest frequency.

2. The apparatus of claim 1, wherein the location code of the consumer is a zip code.

3. The apparatus of claim 1, wherein the set of instructions includes instructions which when executed by the processor cause the apparatus to
use the assigned location code to access demographic data for residents residing in that location code;
use the accessed demographic data to infer information regarding the financial or socio-economic status of the consumer; and
based on the inferred financial or socio-economic status of the consumer, develop a marketing plan for a product or service directed to the consumer.

4. The apparatus of claim 1, wherein the threshold criteria are based on or more of the number of transactions involving the consumer, the number of transactions involving the consumer occurring within a specified time period, the number of card present transactions involving the consumer, or the number of card present transactions involving the consumer occurring within a specified time period.

5. The apparatus of claim 1, wherein filtering the set of payment transaction data corresponding to card present transactions to remove payment transaction data corresponding to transactions conducted with merchants having a specified set of merchant category codes further comprises removing payment transaction data corresponding to transactions conducted with merchants having a merchant category code that corresponds to a travel related transaction.

6. The apparatus of claim 5, wherein the merchant category code that corresponds to a travel related transaction includes a merchant category code corresponding to one or more of an auto rental, an airline, a hotel, a motel, a travel agency, or a cruise line.

7. The apparatus of claim 1, wherein the decision rule is based on determining the location code in which the greatest amount of money is spent by the consumer.

8. The apparatus of claim 1, wherein the decision rule is based on determining the location code in which a specified type or specified types of transactions are most likely to occur.

9. The apparatus of claim 3, wherein the demographic data includes one or more of census data, Internal Revenue Service data, income data, educational level data, disposable income data, or home ownership data.

10. The apparatus of claim 3, wherein the marketing plan further comprises a marketing plan for one or more of a payment transaction account, a loyalty program, or a financial planning service.

11. A method of determining a location code of the residence of a consumer, comprising:
accessing payment transaction data for payment transactions involving the consumer;
determining if the accessed payment transaction data satisfies a threshold criteria for further processing to determine the location code of the residence of the consumer;
filtering the accessed payment transaction data to select a set of payment transaction data corresponding to card present transactions;
filtering the set of payment transaction data corresponding to card present transactions to remove payment transaction data corresponding to transactions conducted with merchants having a specified set of merchant category codes;
processing the remaining payment transaction data to determine a merchant location code for each transaction, the merchant location code corresponding to a location of a merchant that participated in each transaction;
determining one or more of the merchant location codes that occur with the greatest frequency;
applying a decision rule if more than one merchant location code occurs with the greatest frequency; and
assigning the consumer location code to be the determined merchant location code that occurs with the greatest frequency or the outcome of applying the decision rule if more than one merchant location code occurs with the greatest frequency.

12. The method of claim 11, wherein the location code of the consumer is a zip code.

13. The method of claim 11, further comprising:
using the assigned location code to access demographic data for residents residing in that location code/zip code;
using the accessed demographic data to infer information regarding the financial or socio-economic status of the consumer; and
based on the inferred financial or socio-economic status of the consumer, developing a marketing plan for a product or service directed to the consumer.

14. The method of claim 11, wherein the threshold criteria are based on one or more of the number of transactions involving the consumer, the number of transactions involving the consumer occurring within a specified time period, the number of card present transactions involving the consumer, or the number of card present transactions involving the consumer occurring within a specified time period.

15. The method of claim 11, wherein filtering the set of payment transaction data corresponding to card present transactions to remove payment transaction data corresponding to transactions conducted with merchants having a specified set of merchant category codes further comprises removing payment transaction data corresponding to transactions conducted with merchants having a merchant category code that corresponds to a travel related transaction.

16. The method of claim 11, wherein the decision rule is based on determining the location code in which the greatest amount of money is spent by the consumer.

17. The method of claim 13, wherein the demographic data includes one or more of census data, Internal Revenue Service data, income data, educational level data, disposable income data, or home ownership data.

18. A method of marketing a product or service to a consumer, comprising:
accessing payment transaction data for an account associated with the consumer;
processing the accessed data to identify transaction data for one or more card present transactions;
processing the transaction data for the one or more card present transactions to remove data for transactions occurring at merchants associated with a specific merchant category code;
determining a location code associated with the greatest number of the one or more card present transactions not removed from the data;
assigning the determined location code to be the location code of the residence of the consumer;
using the assigned location code to access demographic data for residents residing in that location code;
using the accessed demographic data to infer information regarding the financial or socio-economic status of the consumer; and
based on the inferred financial or socio-economic status of the consumer, developing a marketing plan for the product or service directed to the consumer.

19. The method of claim 18, wherein processing the transaction data for the one or more card present transactions to remove data for transactions occurring at merchants associated with a specific merchant category code further comprises removing payment transaction data corresponding to transactions conducted with merchants having a merchant category code that corresponds to a travel related transaction.

20. The method of claim 18, wherein the location code is a zip code.
